(19) United States
(12) Patent Application Publication
(10) Pub. No.: US 2008/0247505 A1
(43) Pub. Date: Oct. 9, 2008

(54) XRAY DEVICE FOR PLANAR TOMOSYNTHESIS

(76) Inventors: Rohit Patnaik, Carlsbad, CA (US); Dale Thayer, San Diego, CA (US)

Correspondence Address: Rohit Patnaik, 3409 Corte Brezo, Carlsbad, CA, 92009, US

(21) Appl. No.: 11/972,946

(22) Filed: Jan. 11, 2008

Related U.S. Application Data
(60) Provisional application No. 60/910,645, filed on Apr. 7, 2007.

(51) Int. Cl. H05G 1/60

(52) U.S. Cl. 378/10

(57) ABSTRACT

The present invention is claimed as an apparatus and a method for acquiring multi-angle images for a region of interest. The apparatus includes a x-ray source producing a beam of radiation; a surface to support the region of interest that moves the region of interest to at least two locations; and a x-ray detector located to receive a portion of the beam that has passed through the region of interest, the x-ray detector producing from the received portion of the beam an image. In another apparatus the surface that supports the region of interest and the detector move simultaneously while the x-ray source remains fixed.

### FIELD OF THE INVENTION

The present invention relates generally to x-ray imaging systems and methods. This particular invention relates to x-ray tomosynthesis inspection techniques and systems.

### BACKGROUND OF THE INVENTION

With the ever decreasing size of parts and increasing density of solder connections on populated printed circuit boards (PCB), the access to these solder connections have become very difficult. The past practice of visually inspecting PCB's has become extremely difficult and strenuous. Some form of automated analysis is required. Electrical testing which was more of a norm in the past is now challenged as there is little or no room to place measurement probes. There are various other modes of inspection available in the market place with potential advantages and disadvantages depending upon the problem being solved.

One important device class becoming popular is devices such as BGA's or Ball Grid Arrays. These devices have an array of balls/bumps that make contact and fuse with the pads/solder on PCB's. The advantages of using such devices are that you can get a large number of connections per unit area but the disadvantages are that these connections are not visible under standard light and thus other modes such as x-rays are used. But often the part itself occludes the defect signature that needs to be seen. In these cases 3-D techniques that reconstruct a digital slice representing a single plane passing through the object at a specific elevation are employed to “see” through the occlusion and create slices. These methods require imaging the portion to be seen using x-rays as the source using a beam that is incident to the object to be imaged at various angles. The generated slice is very useful in analyzing the qualities of the solder joint and then to make a decision regarding its validity.

In a typical configuration based upon a U.S. Pat. No. 4,688,241 issued to Richard S. Peugot, the tomosynthesis method utilizes a steerable x-ray tube, a large detector, an object positioned in a plane between the detector and the source, such that the electron beam passes through the center of the object and are collected at the detector and acquired through a complex arrangement of mirrors and motors. The main disadvantages are that this leads to a lot of moving parts that need to be synchronized very precisely, not to mention the large expensive detector and the expensive steerable tube.

In another configuration based upon a U.S. Pat. No. 6,748,046, issued to Dale Thayer, the method is greatly simplified and made cheaper in cases where a complete PCB board is to be analyzed. The method requires fixed tic-tac-toe image arrangement or a hexagonal image arrangement and also the entire field of view is not utilized for the view being analyzed. The angle of incidence which may be critical to “seeing” defects may be limited as well.

### SUMMARY OF THE INVENTION

Our proposal describes a method that is both inexpensive and efficient with respect to size of PCB. The use of a standard sealed tube enables us to use a method that is both inexpensive and the system architecture makes it efficient in terms of angles achieved to have an effective inspection system.

### BRIEF DESCRIPTION OF THE DRAWINGS

FIG. 1 illustrates the method described with only one of the multi-angle images being acquired.

FIG. 2 illustrates the same method but shows another of the multi-angle images from a different direction being acquired.

FIG. 3 shows the position of the object of interest or the region of interest at some of the acquisitions.

FIG. 4 shows the position of the portion of the detector being used at each of the acquisition.

FIG. 5 illustrates another method described with only one multi-angle image being acquired. In this case both the x-y table and the detector are moving while the source is fixed.

FIG. 6 illustrates another method described with another multi-angle image being acquired. In this case both the x-y table and the detector are moving while the source is fixed.

### DETAILED DESCRIPTION OF PREFERRED EMBODIMENTS OF THE INVENTION

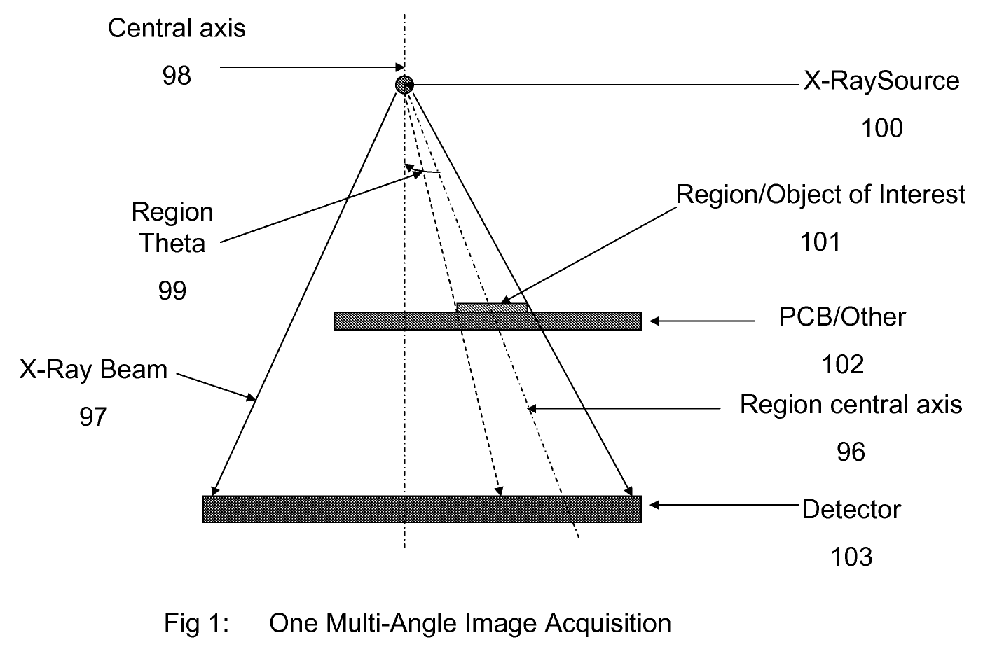

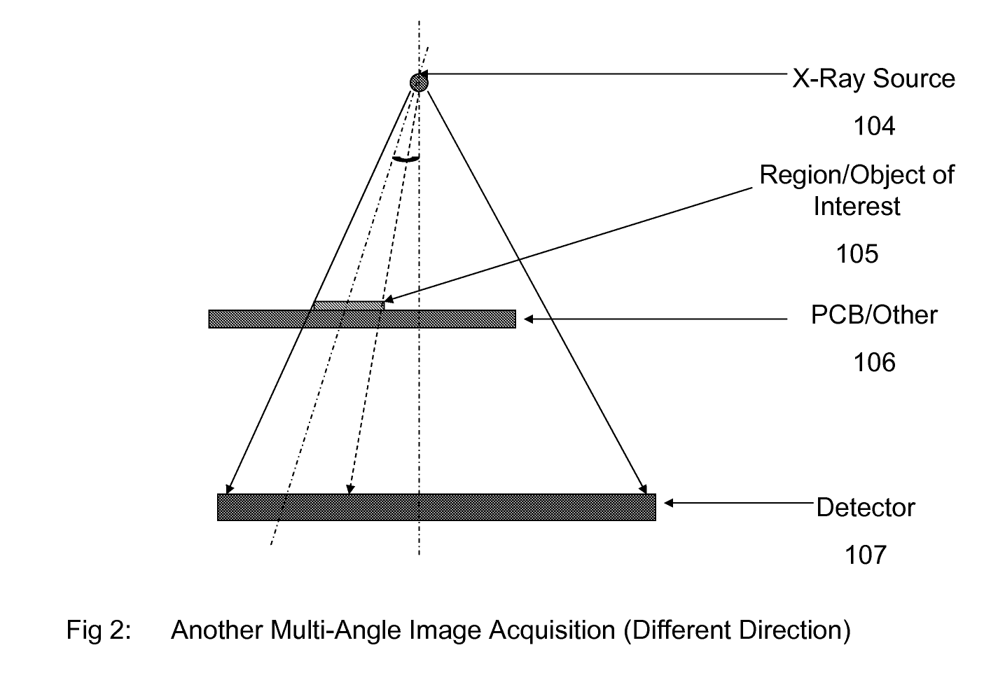

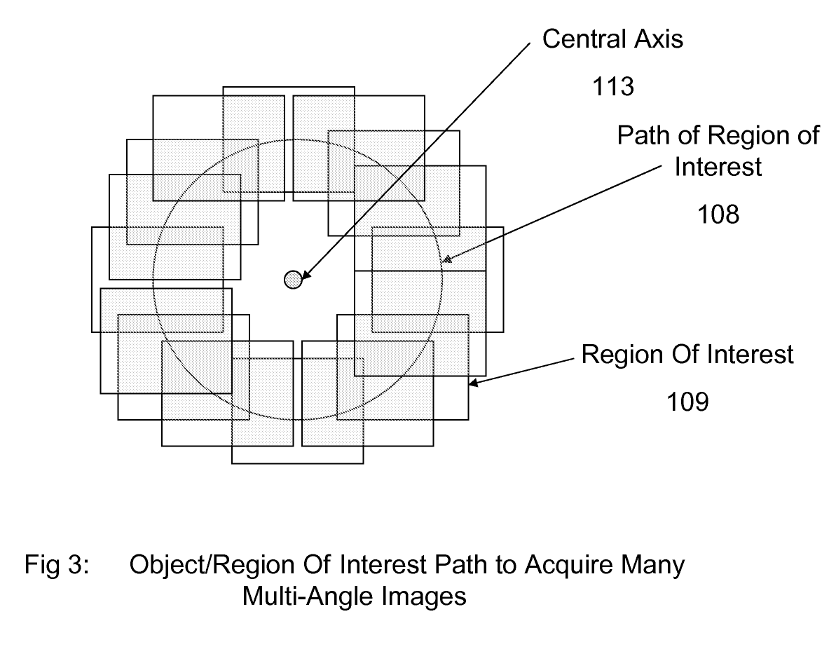

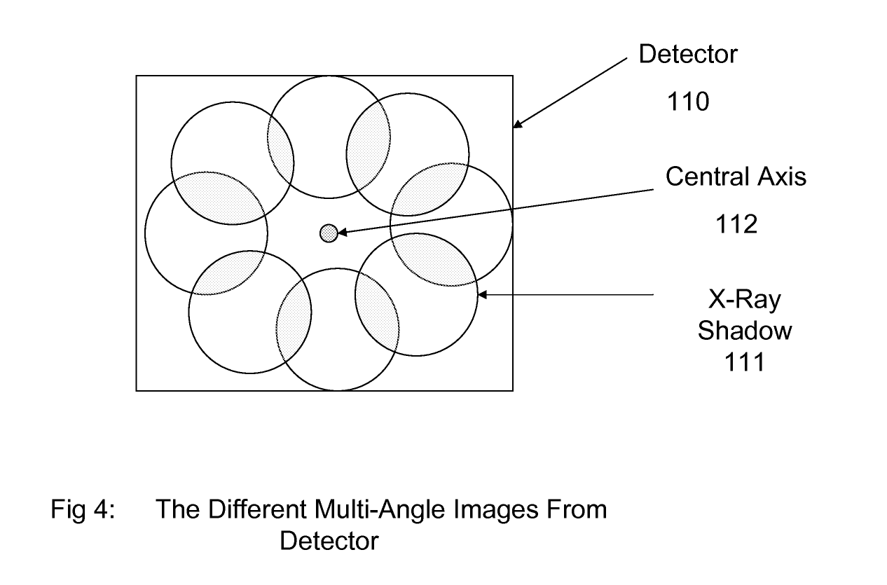

The presently preferred embodiments are described with reference to FIG. 1-4. FIG. 1 shows an x-ray source 100, a x-ray detector 101, an electronic PCB assembly 102 with an assembled part 101. Although the figure shows a PCB assembly 102 with assembled parts 101, this is applicable to any object or region of interest of an object 101 which may be for example a part of an object/objects and the PCB. The x-ray source 100 emits x-rays that are attenuated as they obliquely pass through the assembled part or region of interest and the printed circuit board. The attenuated x-rays passing through the region of interest impinge on the coated scintillating material converts to visible light on the x-ray detector 103 which in turn is converted to an electrical charge signal that is read out as a digital image. FIG. 2 shows the same architecture as the FIG. 1 except that the position of the printed circuit board 106 has moved to a different position to expose the same region of the printed circuit board assembly 105 to the x-ray source from a different direction. The x-ray source 104 is the same as the x-ray source 100 and the detector 107 is the same as the detector 103 but a different part of the detector is being utilized for the purpose. The x-ray source 100 and the x-ray detector 103 are fixed in any configurations but may be movable on an independent vertical axis. The central axis 98 passes through the mid-point of the x-ray source and is perpendicular to the detector. A horizontal x-y table may hold the printed circuit assembly 102 and move it around in that plane. The PCB assembly or the object or the object region of interest 102 moves relative to the x-ray source 100 and the x-ray detector 103 and is at an angle theta 99 to the central axis 98. The area of interest is moved to different locations along a pre-determined path. Images at a minimum of two such positions are required so as to be combined together using tomo-synthesis algorithms to create slices parallel to the x-y plane which is also the plane perpendicular to the central axis. However there is no limit to the number of images at different positions that can be combined tomosynthetically and more is generally better. In practice however there are always limits on time and therefore one has to limit the number of acquisitions.

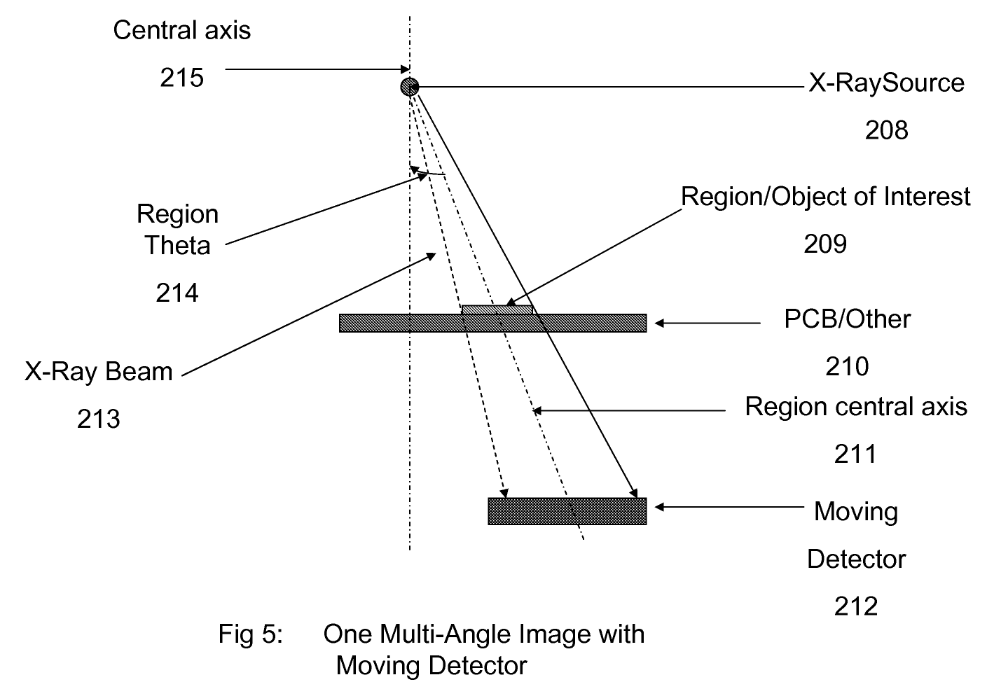

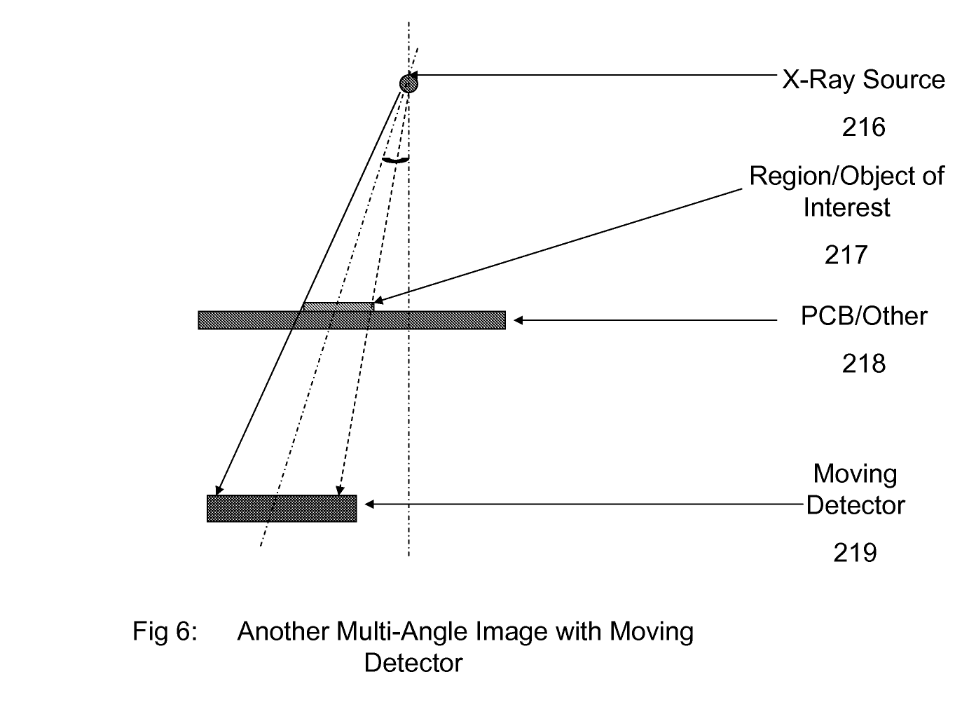

In another embodiment shown in FIG. 5-6, FIG. 5 shows an x-ray source 208, a movable x-ray detector 212, an electronic PCB assembly 210 with an assembled part 209. The advantage of such a system is that the detector can be smaller and fully utilized. The motion of the detector can allow a larger angle of incidence which means one can generate better tomosynthetic images. Although the figure shows a PCB assembly 210 with assembled parts 209, this is applicable to any object or region of interest of an object 209 which may be for example a part of an object/objects and the PCB. The x-ray source 208 emits x-rays that are attenuated as they obliquely pass through the assembled part or region of interest and the printed circuit board. The attenuated x-rays passing through the region of interest impinge on the coated scintillating material thus converting to visible light on the x-ray detector 212 which in turn is converted to an electrical charge signal that is read out as a digital image. FIG. 6 shows the same architecture as the FIG. 5 except that the position of the printed circuit board 218 has moved to a different position to expose the same region of the printed circuit board assembly 218 to the x-ray source but at a different direction. The x-ray source 216 is the same as the x-ray source 208 and the detector 219 is the same as the detector 212.

The x-ray source 208 is fixed but the x-ray detector 212 is moving in its own plane. However both may be movable on an independent vertical axis. A horizontal x-y table may hold the printed circuit assembly 210 and move it around in a plane parallel to the plane of the detector. The PCB assembly or the object or the object region of interest 209 moves relative to the x-ray source 208 and the x-ray detector 212 and is at an angle theta 214 to the central axis 215. The area of interest is moved to different locations along a pre-determined path. Images at a minimum of two such positions are required so as to be combined together using tomosynthesis algorithms to create slices parallel to the x-y plane which is also the plane perpendicular to the central axis. However there is no limit to the number of images at different positions that can be combined tomosynthetically and more is generally better. In practice however there are always limits on time and therefore one may have to limit the number of acquisitions.

What is claimed is:

1. An apparatus for acquiring X-ray images of a region of interest, comprising:
a source producing a beam of radiation; a surface to support the region of interest that moves the region of interest to at least two locations; and a X-ray detector located to receive a portion of the beam that has passed through the region of interest, the X-ray detector producing from the received portion of the beam an image.

2. The apparatus of claim 1 wherein the electronic representations of a region of interest are transferred from the detector to a processor for processing into images of the region of interest.

3. The apparatus of claim 1 further comprising a processor to combine at least two digital representations of the region of interest to produce a tomosynthetic image.

4. The apparatus of claim 1 wherein the support surface may be moveable to position the regions of interest within the beam.

5. An apparatus for acquiring X-ray images of a region of interest, comprising:
a source producing a beam of radiation; a surface to support the region of interest that moves the region of interest to at least two locations; and a X-ray detector supported by a second surface to move the x-ray detector to receive a portion of the beam that has passed through the region of interest, the X-ray detector producing from the received portion of the beam an image.

6. The apparatus of claim 5 wherein the electronic representations of a region of interest are transferred from the detector to a processor for processing into images of the region of interest.

7. The apparatus of claim 5 further comprising a processor to combine at least two digital representations of the region of interest to produce a tomosynthetic image.

8. The apparatus of claim 5 wherein the support surface may be moveable to position the regions of interest within the beam.
